(19) United States
(12) Patent Application Publication
(10) Pub. No.: US 2012/0253939 A1
(43) Pub. Date: Oct. 4, 2012

(54) METHOD AND APPARATUS FOR PROCESSING ADVERTISING CONTENT BASED ON POLICY DATA

(75) Inventors: Nikolai Grigoriev, Brossard (CA); Davis Fields, San Francisco, CA (US); Ian Justin Oliver, Soderkulla (FI)

(73) Assignee: Nokia Corporation, Espoo (FI)

(21) Appl. No.: 13/100,061

(22) Filed: May 3, 2011

Related U.S. Application Data
(60) Provisional application No. 61/470,234, filed on Mar. 31, 2011.

(51) Int. Cl. G06Q 30/00

(52) U.S. Cl. 705/14.61; 705/14.49

(57) ABSTRACT

An approach for enabling advertising content to be processed for use in connection with an application based on one or more policies is described. An advertising component determines one or more user interface state changes associated with one or more applications executing at a device. The advertising component then determines one or more policies for presenting advertisement information at the one or more applications, the device, or a combination thereof. Processing of the one or more policies is then performed to determine advertisement information for presentation at the one or more applications, the device, or a combination thereof based, at least in part, on the one or more user interface state changes.

### RELATED APPLICATIONS

This application claims the benefit of the earlier filing date under 35 U.S.C. §119(e) of U.S. Provisional Application Ser. No. 61/470,234 filed on Mar. 31, 2011, entitled “Method and Apparatus for Processing Advertising Content Based on Policy Data,” the entirety of which is incorporated herein by reference.

### BACKGROUND

Service providers and device manufacturers (e.g., wireless, cellular, etc.) are continually challenged to deliver value and convenience to consumers by, for example, providing compelling network services. One area of interest has been in supporting the ability of advertisers to place advertising content directly within applications executable on the device. For example, many user devices are equipped with email applications, chat applications, browsers, media player applications and other software utilities that are configured to present advertising content to at least a portion of the application user interface during application use. The applications employ static processing logic for rendering advertising content, as supplied by one or more content providers, to the user interface (UI) of the device relative to the current actions being performed by the user via the application. The logic may include rules, developed by the content providers, for indicating how long content can be presented, a rule for changing the advertisement for every UI state change, what to present when the application is idle, etc.

Unfortunately, the processing logic is often coupled with the application or service that retrieves the advertising content from the content providers. Consequently, when an update to a rule for affecting processing of content is required, the content provider must also adapt the processing logic, content retrieval mean, or both to enable the change. Still further, given that the constraints or rules are based on static criteria, the user is limited in their ability to adapt the behavior of the processing logic for affecting the presentment of ads relative to their application.

### SOME EXAMPLE EMBODIMENTS

Therefore, there is a need for an approach for enabling advertising content to be processed for use in connection with an application based on one or more policies.

According to one embodiment, determining one or more user interface state changes associated with one or more applications executing at a device. The method also comprises determining one or more policies for presenting advertisement information at the one or more applications, the device, or a combination thereof. The method further comprises processing and/or facilitating a processing of the one or more policies to determine advertisement information for presentation at the one or more applications, the device, or a combination thereof based, at least in part, on the one or more user interface state changes.

According to another embodiment, an apparatus comprises at least one processor, and at least one memory including computer program code, the at least one memory and the computer program code configured to, with the at least one processor, cause, at least in part, the apparatus to determine one or more user interface state changes associated with one or more applications executing at a device. The apparatus is also caused to determine one or more policies for presenting advertisement information at the one or more applications, the device, or a combination thereof. The apparatus is further caused to process and/or facilitate a processing of the one or more policies to determine advertisement information for presentation at the one or more applications, the device, or a combination thereof based, at least in part, on the one or more user interface state changes.

According to another embodiment, a computer-readable storage medium carries one or more sequences of one or more instructions which, when executed by one or more processors, cause, at least in part, an apparatus to determine one or more user interface state changes associated with one or more applications executing at a device. The apparatus is also caused to determine one or more policies for presenting advertisement information at the one or more applications, the device, or a combination thereof. The apparatus is further caused to process and/or facilitate a processing of the one or more policies to determine advertisement information for presentation at the one or more applications, the device, or a combination thereof based, at least in part, on the one or more user interface state changes.

According to another embodiment, an apparatus comprises means for determining one or more user interface state changes associated with one or more applications executing at a device. The apparatus also comprises means for determining one or more policies for presenting advertisement information at the one or more applications, the device, or a combination thereof. The apparatus further comprises means for processing and/or facilitating a processing of the one or more policies to determine advertisement information for presentation at the one or more applications, the device, or a combination thereof based, at least in part, on the one or more user interface state changes.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling advertising content to be processed for use in connection with an application based on one or more policies, according to one embodiment;

FIG. 2 is a diagram of the components of an advertising component, according to one embodiment;

FIG. 3 is a diagram of a ladder diagram depicting interaction between an advertising system, an advertising service and an application of a user device, according to one embodiment;

FIGS. 4A-4D are flowcharts of a process for providing enabling advertising content to be processed for use in connection with an application based on one or more policies, according to one embodiment, according to various embodiments;

FIG. 5 is a diagram of a user interface changing states for rendering a transformation of advertising content based on one or more policies, according to one embodiment;

FIGS. 6A-6F are diagrams of a user interface of a device for enabling advertising content to be processed for use in connection with an application based on one or more policies, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for providing navigation information based on route exception information received from various users travelling within a common area are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the various exemplary embodiments are described with respect to applications and services for supporting in application advertising, it is contemplated that these embodiments have applicability to any data protocols, methodologies or systems for supporting content processing, content publishing, media presentment and the like.

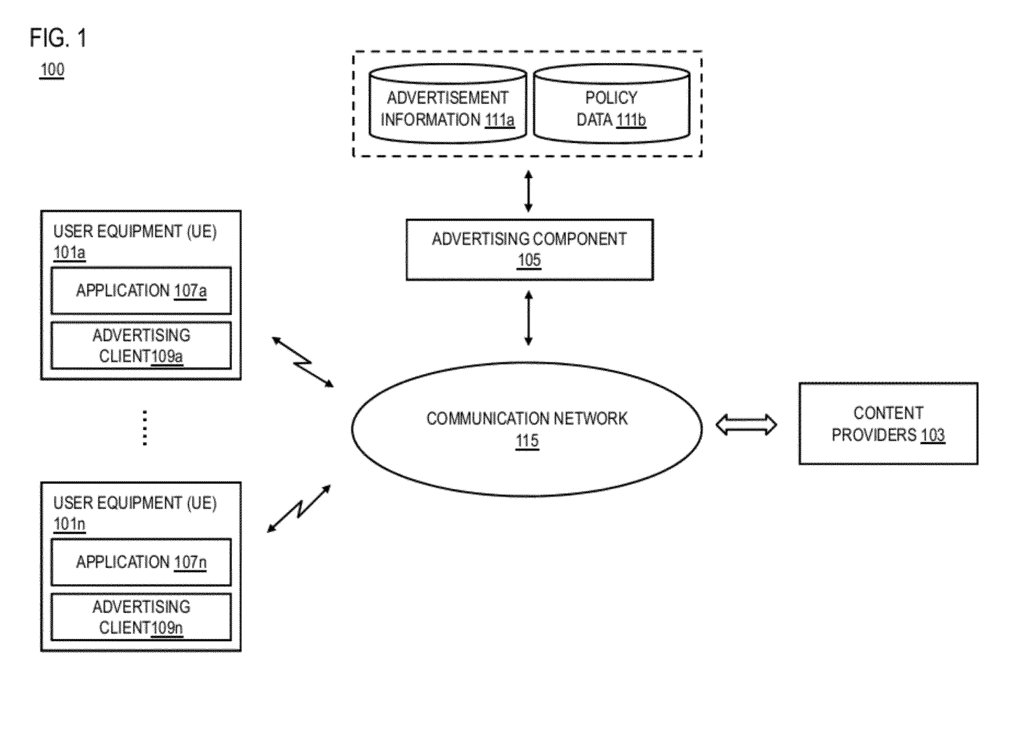

FIG. 1 is a diagram of a system capable of enabling advertising content to be processed for use in connection with an application based on one or more policies, according to one embodiment. By way of example, the system enables one or more providers of advertising content and information to various user devices, i.e., user equipment (UE) 101a-101n for presentment concurrent with operation of an application of the device 1007a-107n. The system is also configured to enable the updating and generating of policy data 111b for regulating and/or controlling execution of the advertising information 111a by respective UE 101a-101n relative to determined changes in the state of the user interface of the UE 101a-101n during application 107a-107n execution.

“Advertising information” may include, for example, any data and/or information useful for enabling the conveyance of a message regarding a product, service, person, event, etc., or a combination thereof. As will be discussed more fully later on, the advertising information may include, but is not limited to, textual, graphical and media content (e.g., audio, video) as well as other information and details for enabling effective processing of the advertisement information amongst various presentment platforms. The other information may include metadata, device processing information, contextual data, profile information and the like for facilitating execution of advertising based content. Service providers, product manufacturers, and/or third party content providers generate and convey advertising information in various forms for inducing individual users or groups to purchase their services, features and products. One means is through the presenting of advertisement information in association with various applications and/or services available to the device such as messaging, navigation, maps, social networking, media (e.g., video, audio, images, etc.) and game. For example, a messaging application may display, in a portion of a graphical user interface, the advertisement in parallel with presenting the messaging features. For the purpose of illustration, advertising information may be referred to synonymously with advertisement unless otherwise noted.

To support this capability, typically the applications employ static processing logic for rendering the advertising content to the display of the device. Advertising content is supplied by one or more content providers, including the application developer, user device service provider, advertising platform, network operations, directly by the seller of the good or service, or a third party content source. An advertisement widget or service may operate in connection with the application for fetching the advertising content from the various providers, caching resources, responding to user actions regarding the advertisement (e.g., user clicks on the advertisement). The primary reason for using an advertisement widget versus allowing each application to perform these tasks is to maximize resource allocation, application efficiency and network/bandwidth utilization. For example, while advertisements can be presented concurrent with the application, processing of the advertisement must be seamless and performed without impeding the user experience (e.g., no additional delay can be tolerated). Consequently, advertising content must be effectively synchronized with the user interface (UI), particularly as the user engages the application to cause state changes in the UI.

With respect to a UI of an application, a “state change” may include, for example, any adaptation, updating or refreshing of data as presented to a display of a device during execution of an application. This includes, but is not limited to, a screen change or refresh, adaptation of textual, graphic or media data, a formatting change, color change or size change, or any other alteration of graphics primitives presented via a display (e.g., monitor, screen) in connection with the operating system (O/S), application programming interfaces (APIs) and other functional elements of the device and/or application. State changes may occur within an application's user interface in response to interaction information, or stimuli, provided by a user of the application (e.g., touch input, mouse over), one or more users of other applications at other user devices (e.g., a communication session between different devices and applications), a process or thread executed by another application or the operating system of the device, or a combination thereof. In certain embodiments, the interaction information is suggestive of the context in which the application is employed relative to the user, the device, other devices, other applications of the other devices, etc.

As state changes occur during application use, the advertisements must still be synchronized with the display, changed or adapted accordingly. Processing rules and constraints employed by the advertising widget for ensuring this operation may include, for example:
Do not display the advertisement beyond X seconds
Advertisement expires on dd/mm/yy at hh:mm
When the user is idle, rotate advertisements every X seconds while on the same screen
Preserve the same advertisement when transitioning from UI state A to UI state B
When the device is offline display image A instead of the advertisement;
When condition X is met, display the out-of-context advertisement pushed by the backend
When a mobile device such as a cellular phone is not on home network, limit the daily bandwidth usage for advertisement to X kilobytes
   The processing rules and criteria executed by the advertising widget are developed by the content providers.

The above described constraints or rules are based on static conditional criteria—i.e., IF a predetermined condition is met, THEN execute the advertisement in a predetermined manner. Consequently, the user cannot exercise the discretion of varying the rules or criteria for affecting presentment of advertisements to fit their taste. Furthermore, the logic for processing the advertising content is usually application specific, and therefore, built directly into the widget. When an update to a rule is required, the content provider must also adapt the widget. There is currently no convenient solution for enabling content providers to readily update rules and advertising information without having to adapt the content retrieval or advertising content display means.

To address this problem, a system 100 of FIG. 1 introduces the capability to adapt processing rules for affecting the presentment of advertisement information at a device based on policy data provided by one or content providers 103a. The system 100 includes an advertising component 105, which operates as a backend data system that aggregates advertisement information 111a and policy data 111b generated and provided by the content providers 103a. Once collected, the advertising component 105 delivers the advertisement information, including advertising content, to one or more UE 101a-101n in accordance with the rules and criteria set forth by the policy data 111b. Execution of the advertisement information 111a is carried out by an advertising client 109a-109n, which is configured to operate in connection with the application 107a-107n for enabling presentment of advertisements concurrent with application execution. As user interface (UI) state changes of the application 107a-107n occur due to the detection of interaction information at the UE 101a-101n, the advertising client 109a-109n executes the advertisement information according to the policy data 111b.

The content providers 103 may include, for example, one or more advertisers, one or more advertising platforms, one or more application developers, one or more network operations, one or more service providers, one or more users associated with the device, or a combination thereof. By way of example, the policy data providers access the advertising component 105 in order to dynamically and/or remotely configure policies for impacting processing of advertising information 111a, including advertising content, by applications 107a-107n of the device responsive to UI state changes. Under this approach, the various parties involved in generating and providing advertisement content need not interact with one another, or individual users and UE 101a-101n, to facilitate placement of advertisements at the UE 101a-101n. Also, when a change in the mode or means of processing of the advertising information 111a is required, the content providers 103 need only modify the policies, rules or criteria accordingly as opposed to having to modify or update the actual programmatic instructions of the application 107 and/or the advertising client 109 that enables presentment of advertising content in connection with the application 107.

The content providers 103 that provide advertising information 111a and policy data 111b may include, by way of example, the following:
Device/Application User: primary recipient of the advertisement materials; interacts with the applications 107a-107n of UE 101a-101n to cause UI state changes to occur; operates the user equipment over a communication network 115 as a subscriber with a communication service provider; policies provided by the user may include, for example, user preference based rules, settings and criteria for affecting the type of content being presented, the regularity of advertisements, the subject matter to which the advertisement content pertains, etc.
Network Operations: provides the support required for ensuring effective delivery of advertisement information 111a to the advertising component 105 via the communication network 115; for example, the operator ensures UE 101a-101n does not generate too much data traffic when the user is away from the home network; policies provided by network operations may include, for example, those rules, settings and criteria for regulating network resource usage.
Advertisement Platform: facilitates delivery of advertisement information 111a to the advertising component; generally, the content is developed by one or more advertisers directly or third-party content providers operating on behalf of the advertisers; in addition to providing specific graphic, textual and media content for comprising an advertisement, policies provided by the advertising platform may include, for example, those rules, settings and criteria for regulating the placement, positioning, relevancy and overall behaviour of advertisements during and throughout execution of the application 107a-107n.
Application Developer: provides the application 107a-107n that uses the advertising component 105 to deliver advertisement content; the developer deploys the application to UE 101a-101n and collects part of the advertisement revenue generated from displaying of the advertisements within the application 107a-107n; policies provided by the application developer may include, for example, those rules, settings and criteria for regulating processing of specific advertisement information 111a relative to the unique features and characteristics of the application 107a-107n, the UE 101a-101n, the underlying operating system and application programming interfaces (APIs) of the UE 101a-101n.

It is noted that the application developer and advertisement platform may collaborate to provide the application service 109a-109n for enabling advertisement content and other information to be presented at UE 101a-101n. By way of example, the advertising client 109a-109n may be downloaded or preinstalled at a device and integrated for use by respective applications 107a-107n as a plug-in processing module. The advertising service 109a-109n processes the policy data in connection with execution of an application 107a-107n by UE 101a-101n, and particularly, one or more user interface state changes of the application.

The advertising component 105 maintains the advertisement information 111a and policy data 111b. In certain embodiments, the advertisement information includes advertisements (ad content) to be presented in connection with or during execution of an application. The ad content may be processed by UE 101a-101n or rendered for presentment by way of graphical, textual or media formats. The advertisement information also includes application identifiers (IDs) (and optional application group identifier). This type of ID specifies the application or application group (suite) for advertisement purposes. Each application that has access to the advertising component 105 is assigned a unique ID. Still further, the advertisement information 111a also comprises data for indicating an application UI context ID. Each unique UI state in the application (e.g., UI state A, B, C . . . to N) has its unique identifier. For example, the displaying of an “Inbox page” of an email application would garner one unique UI context ID, while the displaying of an “Outbox page” would be assigned another. Similar to the application ID, the UI context ID is defined only for advertisement purposes and does not have to be synchronized with other identifiers. It only has to be unique within the scope of the application ID.

The advertising information 111a provided by/procured by the advertising component from the various content providers 103 may also comprise an application UI action ID. The application UI action ID is an abstract identifier for referencing a specific user action, device action, or other device action that leads to the change of the application UI context. For example, user selection of a “Next Page” action button or link within an email application would trigger assignment of an action ID corresponding to the user's action of moving to the next Inbox page. Action IDs are unique only within a particular (source) application UI context, particularly because different applications require different elements and functions to enable their interaction. It is noted that the action ID is a means of referencing and/or labelling interaction information, which may include, but is not limited to, data pertaining to an interaction by a user with the device, an application of the device, one or more users, or one or more users of devices and applications, or a combination thereof.

Another identifier maintained as advertisement information 111a is an advertisement placement ID, which is pre-allocated for the application 107a. The complexity of the application, characteristics of the UI elements of the application, device features, etc., may be used to determine the allocation. By way of example, a simple application may need only one advertisement placement ID given that very few advertisements are intended for placement within the application 107. However, an application that normally displays two ads—one at the top and one at the bottom of the screen—would use two separate advertisement placement IDs.

The policy data 111b as maintained by the advertising component 105 may be implemented as an aggregated data structure expressed using a rule language. Any language can be used for generating the policy including traditional scripting languages such as Python and JavaScript, or more expressive/dynamic languages based on Semantic Web (SWRL). The advertising client 109a-109n processes the policy data 111b, which includes performance of a computation to determine the action and arguments (e.g., criteria) to be executed by the advertising client depending on the external event. The event can be a UI context change notification or a system context event such as “entered no-coverage area”, “entered roaming state”, “battery low”, “device idle” etc. In certain embodiments, it is contemplated that context information regarding the state of the UE 101a-101n, user, other users or other devices may also be used to inform of the occurrence of a state change with respect to a UI, including motion data, location data, speed data and other data as detected by one or more sensors of the UE 101a-101n.

The rules and criteria comprising policy data 111b are provided by the various content providers 103 and vary in form or function. By way of example, a the advertisers/advertising partners may dictate various rules controlling how ads can be fetched, cached, etc., while a advertising platform vendor or third party content provider may dictate how often each device reports the clicks/impressions generated from the ad, the queue size for each advertisement channel, roaming rules, preloaded advertisement rules, etc. The network operations (e.g., an operator) may dictate one or more roaming restrictions, preloaded advertisements, data traffic limits, etc., while the application developer specifies various publishing parameters, application UI configuration, application execution preferences, etc. It is noted that the application developer deals with the advertisement platform vendor to configure the ad displaying rules for the application 107a-107n. The end user may specify rules for dictating an end user agreement to be presented with ads within the application 107a-107n, context preferences, advertisement preferences (e.g., product or industry categories), special needs, etc.

While shown as a separate entity, it is contemplated in certain embodiments that the advertising component 105 may be integrated with the advertising client 109; the operation of which is suitable for supporting in-application advertising. It is noted that integration and/or communication between the advertising component 105, advertising client 109a-109n and one or more applications 107a-107n of respective UE 101a-101n is facilitated by way of a communication network 115. The communication network 115 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof.

In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the advertising component 105, and the content providers 103 communicate with each other and other components of the communication network 115 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

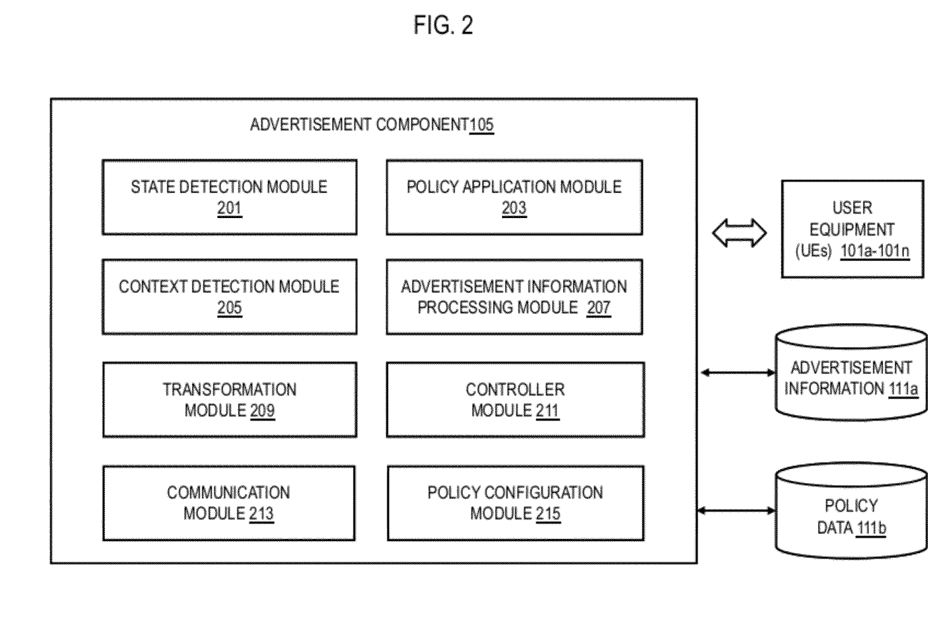

FIG. 2 is a diagram of the components of an advertising component, according to one embodiment. By way of example, the advertising component 105 includes one or more components for providing enabling advertising content to be processed for use in connection with an application based on one or more policies. It is contemplated that the functions of these components may be combined in one or more components or performed by other components of equivalent functionality. In this embodiment, the advertising component 105 includes a state detection module 201, a policy application module 203, a context detection module 205, an advertisement information processing module 207, a transformation module 209, a controller module 211, a communication module 213 and a policy configuration module 215. In addition, the advertising component 105 is also configured to maintain advertising information and policy data in respective databases 111a and 111b, as well as interface with the UE 101a-101n.

In certain embodiments, the state detection module 201 detects a state change to a user interface of an application 107 executed by user equipment (UE) 101. The state change may occur as a result of an action performed by the user, one or more other users, one or more other UEs that interact with the UE, context information, or a combination thereof. By way of example, the state detection module 201 interprets API calls, application processing procedures, internal and external signal transmissions, and other interaction information. Interaction information may include, for example, user interface context information, user interface action information, device context information, system context information, device interaction information (with other devices) or a combination thereof. As noted, the various actions and interface changes may result in the assignment of one or more identifiers for tracking and accounting purposes—i.e., the identifiers being assigned by the state detection module 201 accordingly.

In certain embodiments, the state detection module may also operate in connection with a context detection module. The context detection module 205 may include one or more instructions for detecting the context of a user, UE 101, and/or other users and/or UEs within the context of the application being executed by the UE 101. The context detection module 205 may also enable execution of various sensors of the device to be executed with respect to the application, including a location sensor (e.g., Global Positioning System), a motion sensor, a gyroscope, a speed sensor, etc. By way of example, when a group of devices interact with one another within a given proximity, such as to partake in game facilitated by way of a gaming application at respective devices, the context detection module 205 and state detection module 201 may interact to detect state changes that are the result of this mode of interaction. It is noted that this approach to state detection by the advertising component 105 accounts for all possible interactions that may occur aside from user interaction within a typical mobile device application environment.

In certain embodiments, the policy application module 203 determines one or more policies for presenting advertisement information at the one or more applications in response to a determined state change by the state detection module 201. By way of example, the policy application module selects specific policy information to be applied for a particular type of state interface change occurrence (e.g., determined UI state ID). Of note, the policy application module 203 is configured to analyze the criteria or rules associated with or comprising one or more policies relative to the determined UI state change.

In another embodiment, the advertisement information processing module 207 processes advertising information, as provided by one or more content providers (particularly advertisers or content providers) for presentment via a given application of UE. By way of example, the advertisement information processing module 207 is configured to determine the advertising content type—i.e., media, graphical, textual, as well as translate the advertising content into the necessary format and/or language for use by the operating system of the UE 101. In certain instances, the advertisement information processing module 207 functions as, or in conjunction with, the advertising client 109 of respective UE 101, for ensuring effective gathering, placement and presentment of advertisement content in accordance with policy data 111b.

In certain embodiments, the transformation module 209 operates in connection with the advertisement information processing module to transform advertisement content, when required, based on one or more policies. The transformation module may process the advertisement content intended for display via a UI of UE 101 such that it is modified, altered, refreshed or otherwise transformed commensurate with the detected state change at the UI that triggers execution of a policy. By way of example, the policies may indicate one or more transformation rules applicable/allowable for execution by the application 107 and/or application service 109 responsive to the fulfillment of certain criteria or conditions. The policy data may enable, for instance, free-form transformation, wherein a user is allowed to transform any advertisement. In other instance, transformation can be restricted to certain transformations (e.g., as allowed by advertisers who may provide different transformation options). In the case of free-form transformation, the policy dictates that this option is available to the user whereas, in the latter case, the policy indicates the restrictions/limits.

Exemplary transformations facilitated by the transformation module 209 may include, for example, transforming graphics for an R rated game ad to one suitable for younger children (e.g., the picture may be a place holder or selected from a gallery of suitable alternatives); transforming content based on themes selected by the user; transforming color schemes; transforming sound levels. The transformation module 209 may be configured to perform one or more transformations at a time, where the transformation includes transforming the advertisement information based on (a) a specified age range of a user of the device, (b) one or more user preferences, (c) one or more device capabilities, (d) or a combination thereof. In addition, a transformation may be performed in based on the interaction occurring between the UE and or more other UEs. Under this scenario, the advertisement may be transformed based on group interaction dynamics, including transforming an advertisement to reflect a group rate, group discount, presenting a group offer versus individual offer, etc.

The transformation module 209 also reports the occurrence of a transformation to the advertisers, advertising platforms, one or more application developers, one or more network operations, one or more service providers, one or more users associated with the device. By providing this information to the various content providers 103, they can maintain statistics and data to support ongoing marketing and advertising campaign efforts identify preferences amongst key demographics, etc.

In certain embodiments, the policy configuration module 215 receives policy data 111b from one or more content providers 103. The policy configuration module may specify a particular format of the policy data by the one or more providers for enabling its maintenance as consistent data structure. The policy configuration module may operate in conjunction with a communication module 213 for enabling presentment of a user interface to the various content providers 103 for facilitating the inputting of policy data 111b, the uploading of policy data (e.g., in a specified file format) to the advertising component 105 by way of the network 115, etc. Also, the policy configuration module 215 may also receive advertisement information 111a to be applied respective to one or more policies 111b. It is noted that the policy configuration module 215 supports remote policy configuration capability among various content providers.

In one embodiment, a communication module 213 enables formation of a session over a network 115 between the advertising component 105 and the applications 107a-107n of respective user devices 101a-101n. In certain embodiments, the communication module 213 executes various protocols and data sharing techniques for enabling collaborative execution between UE 101a-101n (e.g., mobile devices, laptops, smartphones, tablet computers, desktop computers) and the advertising component 105 over the communication network 115.

Also, in one embodiment, a controller module 211 is configured to regulate the communication processes between the various other modules for generating and associating tags representing different classifications to a single contact identifier. For example, the controller module 211 generates the appropriate signals to control the communication module 213 for facilitating transmission of data over the network 109.

It is noted that the above described modules 201-215 of the advertising component 105 may be integrated for direct execution by UE 101a-101n, provided as a service by a service provider (e.g., a wireless communication service provider) or a combination thereof.

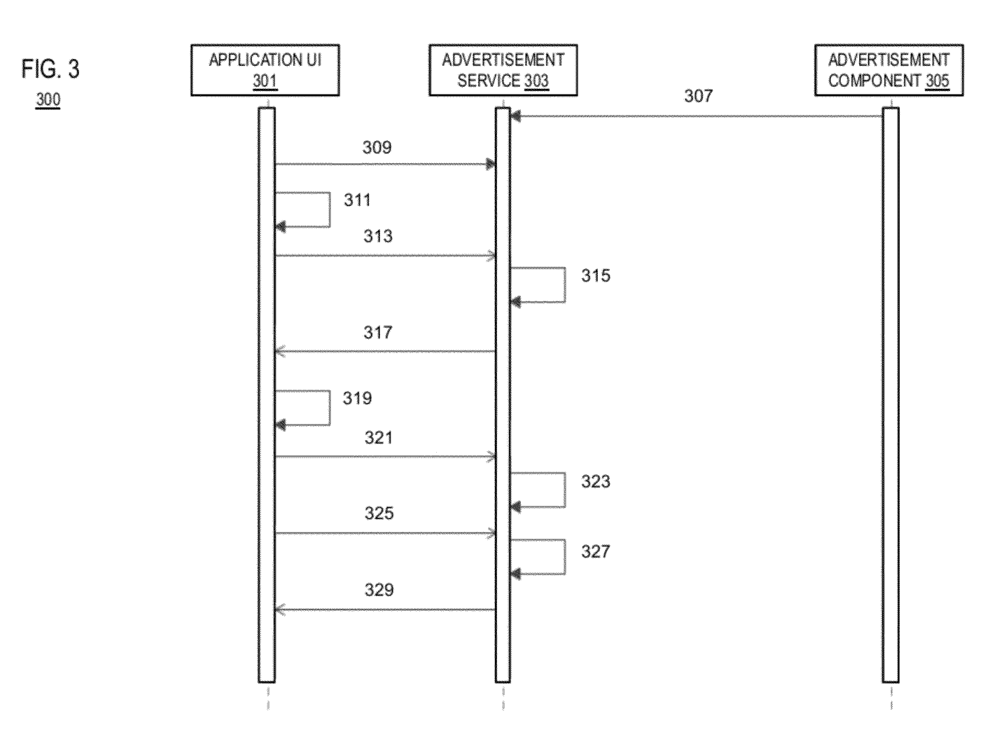

FIG. 3 is a diagram of a ladder diagram depicting interaction between an advertising system, an advertising service and an application of a user device, according to one embodiment. The interaction corresponds to execution of one or more elements of the above described components 201-215, execution by an application 107 of UE 101 responsive to determined interaction information (e.g., a touch by a user, a signal received from another device, a mouse click). In a first step 307, the advertising component 305 procures updated policy data 111b and, if required, updated advertisement information 111a from one or more content providers 103. This information is delivered to the advertising client 303. Per step 309, the application UI 301 is initialized/rendered accordingly to the UE 101. As mentioned previously, the advertising client 303 operates in connection with the application for affecting the presentment of advertisement content to the user via the application UI 301. Upon detecting the occurrence of interaction by the advertising client 303, such as user selection of an application feature (e.g., button, menu, screen toggle), the user interface context ID corresponding to the change in the state of the application UI 301 is returned to the advertising client 303, corresponding to steps 311 and 313 respectively. Based on the determined state change, in step 315, the advertising client 303 then performs a policy data lookup to determine which advertisement to apply given the state change and by what criteria the advertisement should be executed.

In another step 317, the advertising client 303 renders the updated advertisement to the application UI 301 based on the established policy data. Per steps 319 and 321, when another interaction is determined, the user interface context ID corresponding to the change in the state of the application UI 301 is again returned to the advertising client 303. Again, this information is then used by the service 303 to perform a policy lookup, as in step 323. In response to the policy lookup and determined UI state context ID, no change was made to the advertisement. Subsequently, when another UI state change occurs, steps 325 and 327 are performed in the same manner as steps 321 and 323. In this scenario, the policy lookup (step 327) required an updating of the advertisement content, which is submitted by the advertising client 303 for display via the application UI 301. Submission of the updated content by the advertisement service 303 to the application user interface 301 is represented by step 329.

The mechanism for conveniently enabling the updating of rules and logic for processing advertisement content within applications 107a-107n of one or more UE 101a-101n is explained subsequently herein.

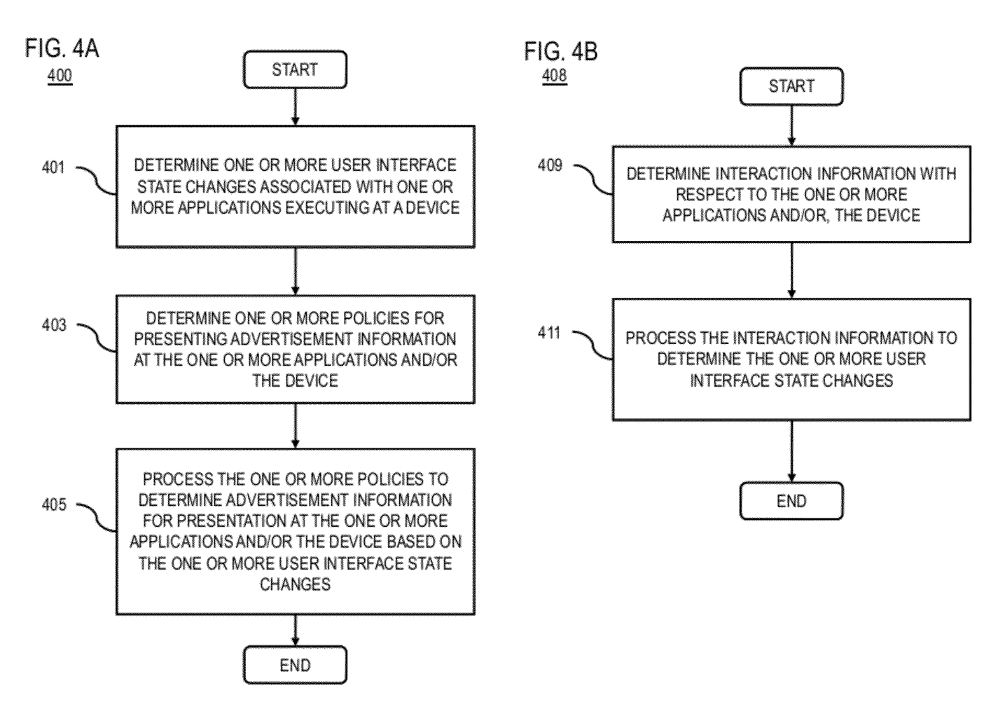

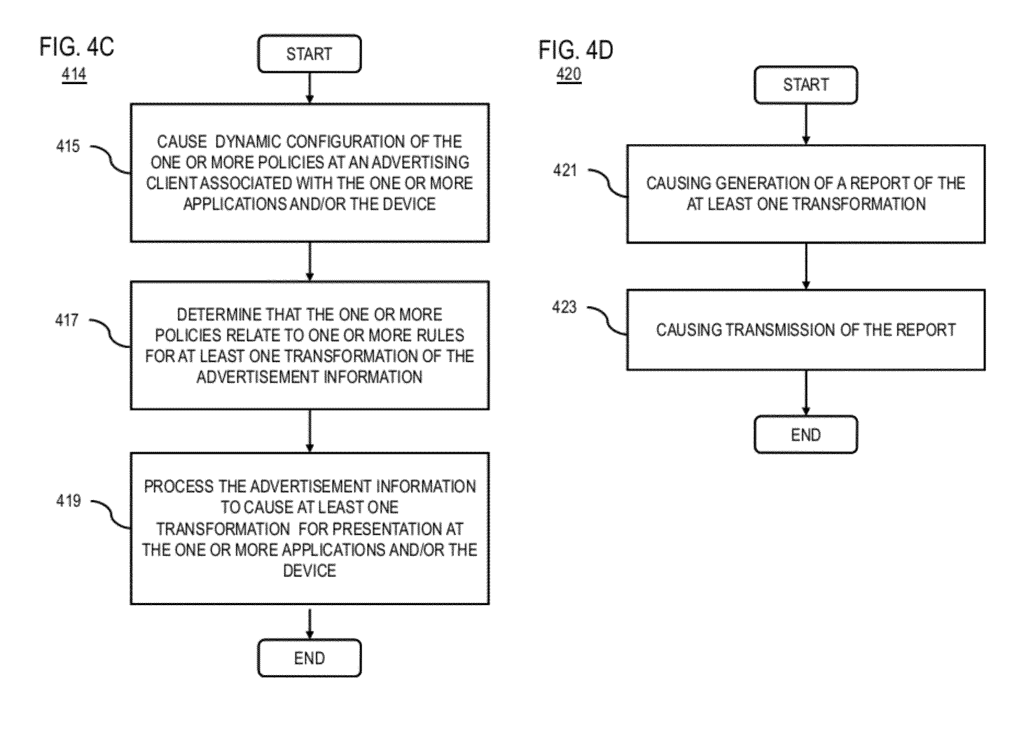

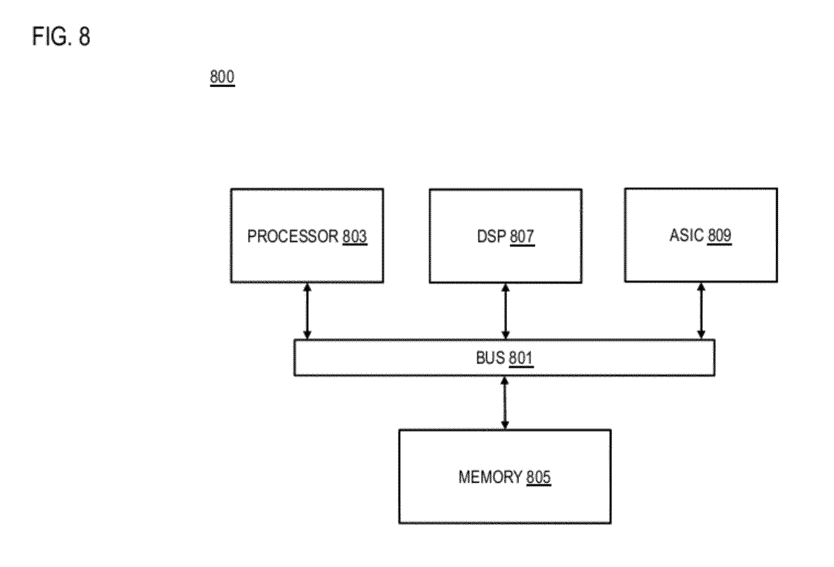

FIGS. 4A-4D are flowcharts of a process for providing enabling advertising content to be processed for use in connection with an application based on one or more policies, according to one embodiment, according to various embodiments. In one embodiment, the advertising component 105 and/or advertising client 109 performs the process 300 and is implemented in, for instance, a chip set including a processor and a memory as shown in FIG. 8. For the purpose of illustration, the processes are described with respect to FIG. 1. It is noted that the steps of the process may be performed in any suitable order, as well as combined or separated in any suitable manner.

In step 400 of process 401, the advertising component 105 determines one or more user interface state changes associated with one or more application executing at a device. As mentioned, the state changes to the user interface occur as a result of interaction information including user interface context information, user interface action information, device context information, system context information, other device interaction information or a combination thereof. In another step 403, the advertising component 105 determines one or more policies for presenting advertisement information at the one or more applications, the device, or a combination thereof. Per step 405, the advertising component 105 processes the one or more policies to determine advertisement information for presentation at the one or more applications, the device, or a combination thereof based, at least in part, on the one or more user interface state changes. As mentioned previously, the advertisement information may include the various identifiers required for referencing of various user interface, device or contextual actions as well as the various advertising content to be rendered to the display.

The policy data 111b as maintained by the advertising component 105 includes, for example, one or more policies and/or the one or more criteria for processing of the policies. Policy information is specified by one or more advertisers, one or more advertising platforms, one or more application developers, one or more network operations, one or more service providers, one or more users associated with the device, or a combination thereof. These content providers 103 push the advertisement information 111a and policy data 111b to the advertising component 105, and update the policies to affect the presentment of advertisement content at the UE 101a-101n.

In step 409 of process 408 (FIG. 4B), the advertising component 105 determines interaction information with respect to the one or more application and/or the device. In another step 411, the component 405 processes the interaction information to determine the one or more user interface state changes. In certain embodiments, the interaction information may also be determined based on the detection of context information, including feedback and data detected by one or more sensors of the UE 101.

In step 415 of process 414 (FIG. 4C), the advertising component 105 causes dynamic configuration of the one or more polices at an advertising client 109 associated with the one or more applications and/or the device. In another step 417, the advertising client 109 and/or advertising component 105 determine that the one or more policies relate to one or more rules for at least one transformation of the advertisement information. As mentioned, the one or more policies indicate the rules for enabling transformation of advertisement content, including rules for enabling dynamic altering of advertisement, restricted transformation, etc. Per step 419, the advertising component 105 processes the advertisement information to cause at least one transformation for presentation at the one or more applications and/or the device.

The transformations performed by the advertising component 105 in connection with the advertising client 109 includes transforming the advertisement information based on a specified age range of a user of the device, one or more user preferences (e.g., preferred industry, hobbies, one or more device capabilities, etc. As noted, the transformation may also be performed based on a group transformation policy basis, such as to account for interaction that may occur between one or more device users at a time. For example, an advertisement for a user executing a photo sharing application may be transformed into a group based advertisement upon detection of other users within the same proximity. By way of this approach, all of the users within the photo sharing group are presented with the same advertisement based on their mutual interaction.

In step 421 of process 420 (FIG. 4D), the advertising component 105 causes generation of a report of the at least one transformation. In another step 423, the advertising component 105 causes transmission of the report to, such as to the one or more content providers 103. Recipients of the report may include, for example, the various advertisers, application developers, network operators, users, etc, or a combination thereof. The report may include statistics for indicating the effectiveness of an advertisement, marketing and/or business development metrics, test marketing data, individual user profile information, group profile information, etc.

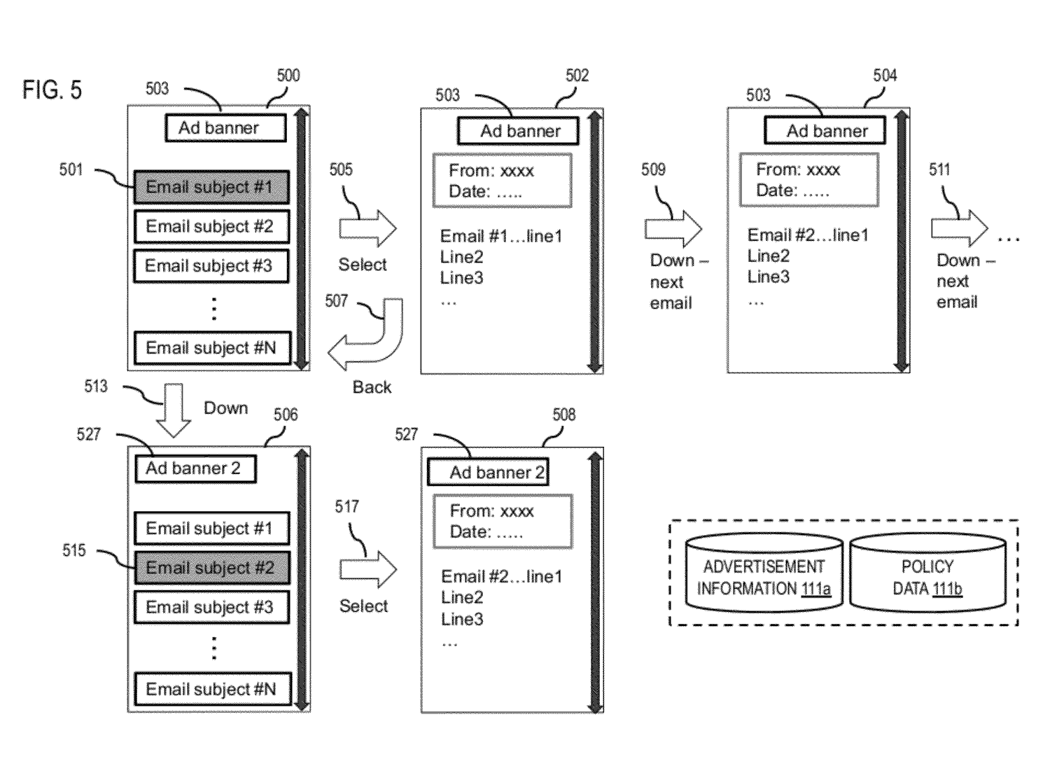

FIG. 5 is a diagram of a user interface displaying a transformation of advertising content based on one or more policies, according to one embodiment. The advertising component 105 ensures the advertisement content (e.g., banner ads, media files) is transformed as UI changes occur. For the purpose of illustration, actions for enabling or causing UI changes are presented as one or more arrows 505-513 and 517. As described below, the actions may be those initiated by user interaction with the device and/or application. Of note, however, actions for causing transformation of content/state changes at the user interface may also be the result of actions such as signal detection, scheduled application invocation (e.g., the activation of alarm) or other like actions.

By way of example, the application is an e-mail application for enabling the viewing and/or generation of messages and other related features. The Inbox of the email application, corresponding to display 500, features various e-mail subjects (e.g., Email Subject #1, referenced as 501) such as received from one or more correspondents. Also featured at the top of the display is an ad banner 503. When a user selects an e-mail subject (e.g., 501), corresponding to an action 505, the screen is updated to show specific detail regarding that subject 501. This adaptation corresponds to a state change at the user interface as represented by updated display 502. It is observed that per the policy data 111b, in this example, the ad banner 503 remains the same despite the UI state change. The same is true when the back button 507 is selected for retrieving the inbox again, when the user moves down 509 to the next email in the list/Inbox, per display 504 and when a subsequence email subject (e.g., Email Subject #2) is selected when the user moves down 511 from email subject 501.

Alternatively, when the user interaction is such that the user moves down 513 (e.g., toggles the Inbox/list) while in the Inbox, as in screen 506, the policy data 111b calls for the presentment of a different banner 527 (e.g., Ad banner 2). This banner 527 remains as the user selects 517 the email subject #2 515 for full viewing per display 508. It is noted that the device application screen displays the application-specific information and has one or more ads (banners) displayed at a portion of the interface. Each application is uniquely identified for advertisement purposes per the various identifiers included as part of the advertisement information 111a. The advertisement transforms at any point in time given a particular UI context state and the ad is displayed in a particular predefined location on the screen. Hence, any user action (e.g., clicking the screen, selecting menu item, pressing a key) or a system event (timer, physical location change) may cause the UI context change.

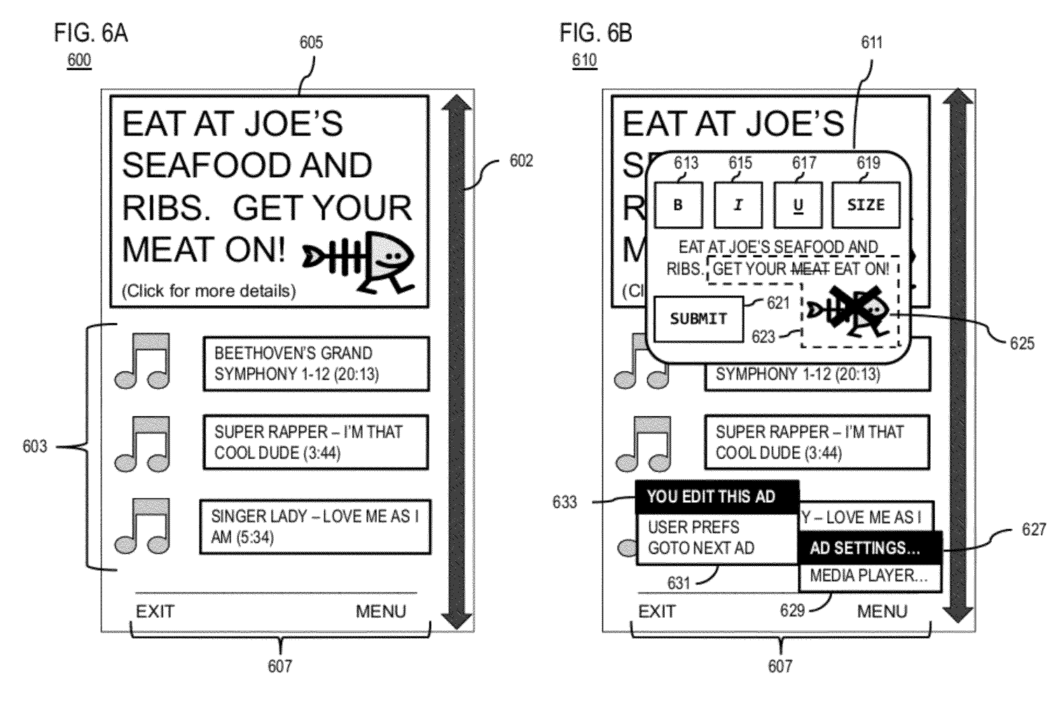

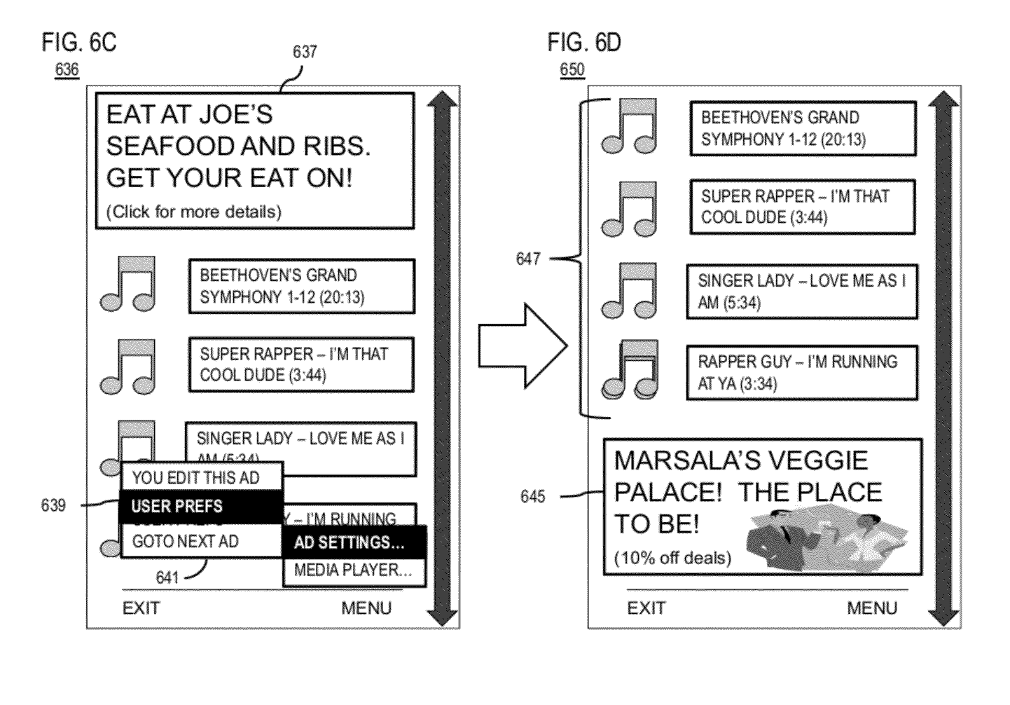

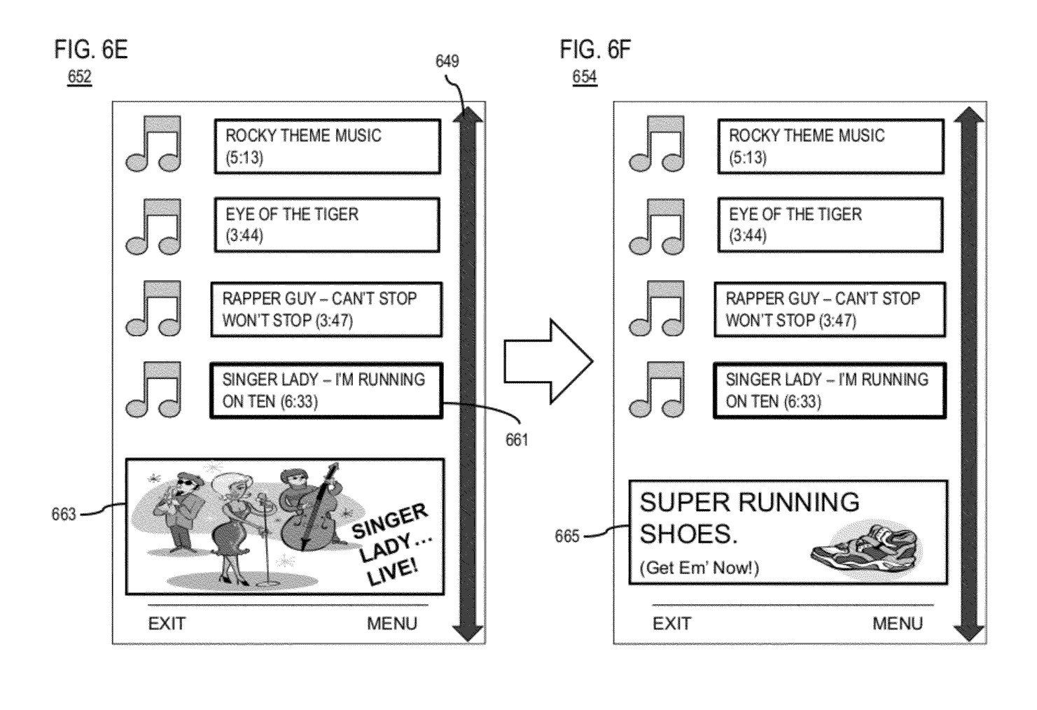

FIGS. 6A-6F are diagrams of a user interface of a device for enabling advertising content to be processed for use in connection with an application based on one or more policies, according to various embodiments. For the purpose of illustration, the diagrams are described with respect to an exemplary use case of a device user accessing a media player application that is configured with an advertising client for supporting ad content presentment according to one or more policies.

In FIG. 6A, a user of a device accesses a media player (e.g., music player) prior to engaging in a morning jog. The media player is loaded to the display 600 for presenting the user's playlist, which includes various audio/song selections 603. Also presented is a scroll bar 602 by which the user may scroll up or down through the playlist to activate selections 603. Another portion of the user interface 600 is for enabling the presentment of advertisement content, which in this example is an advertisement 605 for a seafood restaurant. The user, who is a vegetarian and an animal rights activist, does not like the reference in the advertisement to Meat. Rather than ignore the ad or wait until the advertisement changes, the user decides to investigate their advertising settings and preferences by selecting the “Menu” button of the toolbar 607, as shown in FIG. 6B.

In FIG. 6B, upon selecting the “Menu” button of the tool bar 607, a selection menu 629 is shown to display 610 (representing a change in state of display 600). The selection menu, in this example, gives the user the option to select an “Ad Settings . . . ” menu option 627 for enabling the user to adapt or control the advertisement settings. Alternatively, the user is presented with a “Media Player . . . ” menu option for enabling the user to adapt or control the function of the media player. The user selects the former, which in turn causes presentment of an additional selection menu. It is noted that the UI undergoes various state changes responsive to actions performed by the user with respect to the application UI.

Per the policies made available relative to the application, the advertiser and various policy sources by the advertising platform, the user is presented with various options for selection by the user from another selection menu 631. A “You Edit This Ad” menu option 633 for enabling the user to dynamically edit the advertisement, i.e., in a manner that suits their liking. Other menu options featured via menu 631 include a “User Prefs” and “Goto Next Ad,” which enable the user to modify their advertising content preferences (e.g., areas of interest, hobbies, relative location, age, gender) or advance to another ad respectively. The user decides to select the “You Edit This Ad” menu option 633.

As a result of this selection, a text editor 611 featuring the textual content and graphical content of the advertisement populated into the editor is shown to the display. The text editor also features various action buttons 613-619 for allowing the user to change the format of text, including a Bold (B), Italics (I), Underline and “Size adjustment button respectively. Per the policies configured by the content providers (e.g., application developer, advertisers), the user is presented with detail regarding only a select portion of the message 623 that is allowed to be dynamically modified by the user, which includes only the restaurant slogan and a icon representative of a potential logo 625 the advertiser is test marketing. The user decides to change the size of the message, replace the word “Meat” with “Eat” and delete the icon. It is noted that this capability is afforded by one or more policies, executable by the advertising service, for enabling free-form or dynamic editing policies afforded the user. Per the same policy rules, the user is not allowed to adapt the portion of the message for indicating the name of the restaurant. Hence, policies may be created for enabling selective adaptation of content or other advertising information at the discretion of the one or more content provider(s).

Having made the updates via the editor 611, the user selects the “Submit” action button 621, triggering execution of the advertising service and/or platform to transform the advertisement per the users dynamically applied update. The UI of the media player at display 636 upon transformation of the advertisement 637 is shown with respect to FIG. 6C. Submission of the change results in generation of a report to the one or more content providers. The report includes details regarding the changes made by the user as well as other information for indicating the user preferences, demographics, location, etc. that the policy provider may use in developing future policies. In this example, the updated message 637 is shown suited to the preferences of the user. As was also desired by the user, the advertisement is made to consume a lesser amount of the user interface, thus enabling more song selections to be presented in the playlist at a time (e.g., less scrolling required by the user).

Under this scenario, the user makes no music selection, but instead, decides to further adapt the advertisement 637 to better suit their preferences. To do this, the user selects the “You Edit This Ad” menu option again to change the location of the advertisement 637. In addition, the user selects the “User Prefs” menu option 639 of the selection menu 641. While not shown, the UI of the application undergoes another state change, wherein the user is presented with a pop-up window where they can modify their preferences (not shown). One of the preferences for adapting restaurant and/or food content enables the user to specify a preference for vegetarian cuisine. Per FIG. 6D, the transformed advertisement 645, at a different location of the display 650, is shown. The various music selections 647 are also shown in a new location accordingly.

In FIG. 6E, the user toggles through the playlist featured to the display 652 using the scroll button 649 and selects a song (e.g., audio/media file 661) to play as they jog. User activation of the scroll bar results in yet another UI state change, albeit corresponding to the same page, for presentment of additional user songs in the playlist. The user selects the song 661 “I′m Running on Ten” by the artist Singer Lady. Details regarding the artist, album, track title, year of make, etc., is maintained by the media player application as metadata. Per the policy settings, the advertising content is adapted based on the following criteria, rules, conditions, etc. as maintained as policy data:
IF metadata regarding a song is available
AND, the song is selected by the user or presented as a result of a UI state change,
AND/OR the UI remains inactive for a period of X seconds
THEN, present advertising content pertaining to a song and/or artist featured at the UI via the current UI state

Based on this policy criteria being fulfilled, a transformation of the advertisement 645 (of FIG. 6D) is executed by the advertising component 105. By way of example, the transformed advertisement 663 is for the artist Singer Lady, which is presented to the display 652 based on the determined context information made available in connection with the policy information.

In FIG. 6F, as the user is jogging while listening to the media player, the user device detects unstable motion occurring at the device. Per another policy setting for enabling the instantaneous adaptation of content based on determined interaction information (e.g., device, user or application usage and/or context), the user is able to receive a targeted advertisement 665 (e.g., based on user preferences, history, etc.) regarding running shoes and render this content to the display 654 accordingly. This capability of enabling immediate transformation or updating of an advertisement (e.g., from advertisement 663 to 665) is due, in part, to the policy data being pushed from outside of the portable device—i.e., at the advertising component—thus enabling it to be updated at any moment.

The processes described herein for enabling advertising content to be processed for use in connection with an application based on one or more policies may be advantageously implemented via software, hardware, firmware or a combination of software and/or firmware and/or hardware. For example, the processes described may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

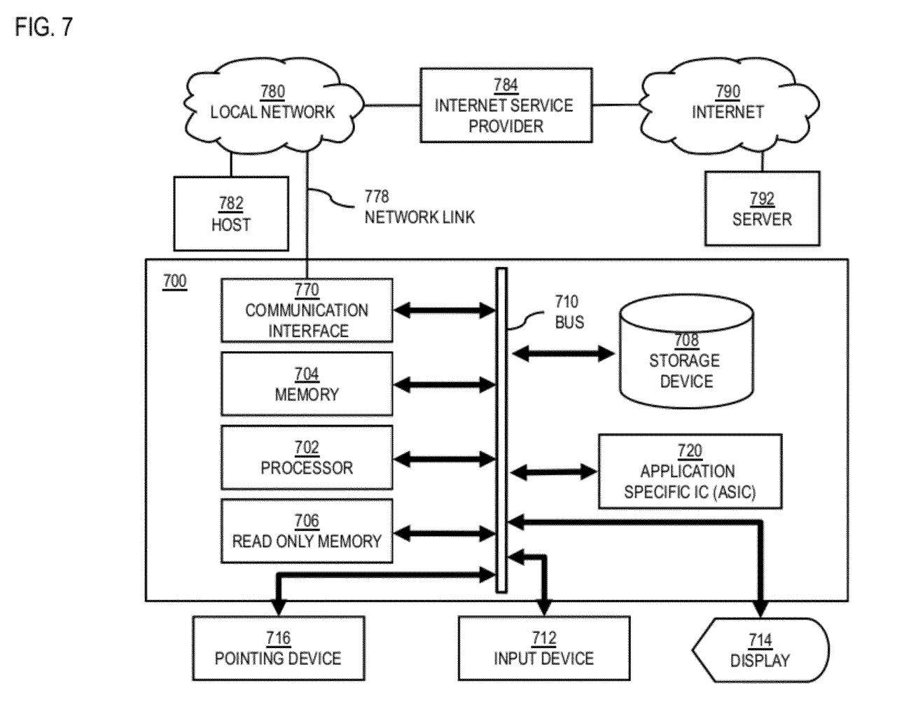

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to enable advertising content to be processed for use in connection with an application based on one or more policies as described with respect to various of the exemplary embodiments, and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of enabling advertising content to be processed for use in connection with an application based on one or more policies.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to enable advertising content to be processed for use in connection with an application based on one or more policies. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for enabling advertising content to be processed for use in connection with an application based on one or more policies. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for enabling advertising content to be processed for use in connection with an application based on one or more policies, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 115 for enabling advertising content to be processed for use in connection with an application based on one or more policies to the UE 101.

The term “computer-readable medium” may include, for example, any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used, for example, to refer to any computer-readable medium except transmission media.

Logic encoded in one or more tangible media includes, for example, one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to enable advertising content to be processed for use in connection with an application based on one or more policies as described in one or more of the exemplary embodiments and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of enabling advertising content to be processed for use in connection with an application based on one or more policies.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include, for example, one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include, for example, one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to enable advertising content to be processed for use in connection with an application based on one or more policies. The memory 805 also stores the data associated with or generated by the execution of the inventive steps.

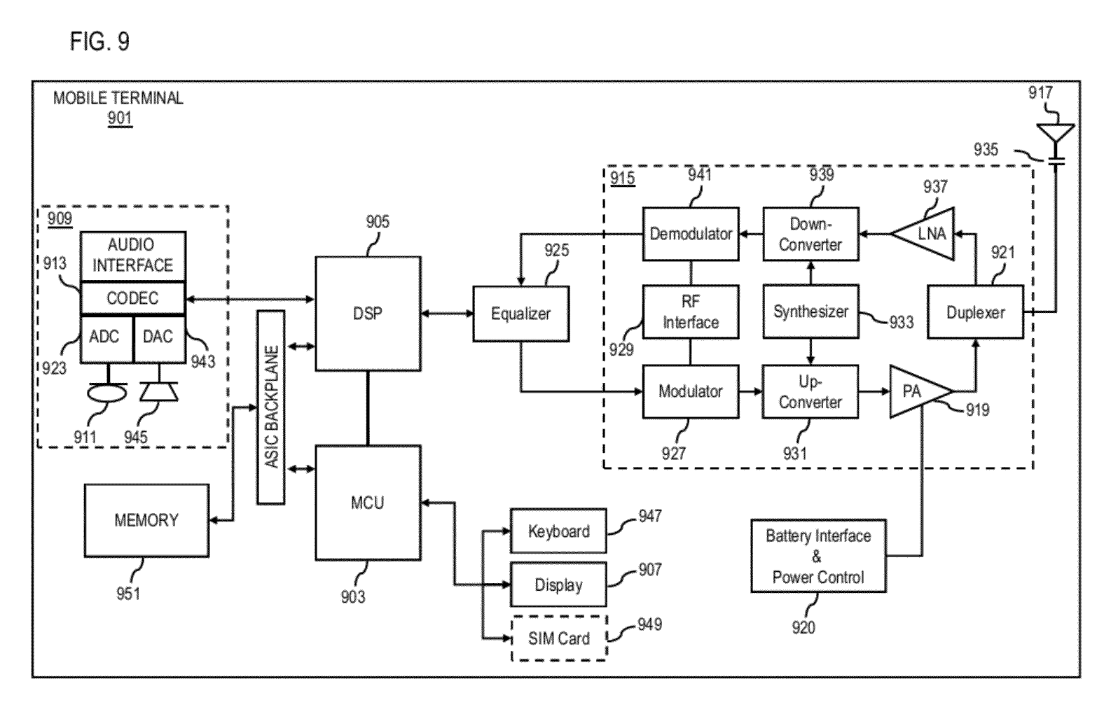

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of enabling advertising content to be processed for use in connection with an application based on one or more policies. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of enabling advertising content to be processed for use in connection with an application based on one or more policies. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to enable advertising content to be processed for use in connection with an application based on one or more policies. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
one or more user interface state changes associated with one or more applications executing at a device;
one or more policies for presenting advertisement information at the one or more applications, the device, or a combination thereof; and
a processing of the one or more policies to determine advertisement information for presentation at the one or more applications, the device, or a combination thereof based, at least in part, on the one or more user interface state changes.

2. A method of claim 1, wherein the (1) data and/or (2) information and/or (3) at least one signal are further based, at least in part, on the following:
interaction information with respect to the one or more applications, the device, or a combination thereof; and
a processing of the interaction information to determine the one or more user interface state changes.

3. A method of claim 2, wherein the interaction information includes, at least in part, user interface context information, user interface action information, device context information, system context information, other device interaction information or a combination thereof.

4. A method of claim 1, wherein the one or more policies specify one or more criteria for determining (a) a duration for presenting the advertisement information, (b) an expiration date and/or time for presenting the advertisement information, (c) a sequence for presenting the advertisement information, (d) the one or more user interface state changes for triggering the presentation of advertisement information, (e) presentation of the advertisement based, at least in part, on network status information, or (f) a combination thereof.

5. A method of claim 4, wherein the one or more policies, the one or more criteria, or a combination thereof are specified, at least in part, by one or more advertisers, one or more advertising platforms, one or more application developers, one or more network operations, one or more service providers, one or more users associated with the device, or a combination thereof.

6. A method of claim 1, wherein the (1) data and/or (2) information and/or (3) at least one signal are further based, at least in part, on the following:
a dynamic configuration of the one or more policies at an advertising client associated with the one or more applications, the device, or a combination thereof.

7. A method of claim 1, wherein the (1) data and/or (2) information and/or (3) at least one signal are further based, at least in part, on the following:
at least one determination that the one or more policies relate, at least in part, to one or more rules for at least one transformation of the advertisement information; and
a processing of the advertisement information to cause, at least in part, the at least one transformation for presentation at the one or more applications, the device, or a combination thereof.

8. A method of claim 7, wherein the at least one transformation includes transforming the advertisement information based, at least in part, on (a) a specified age range of a user of the device, (b) one or more user preferences, (c) one or more device capabilities, (d) or a combination thereof . . . or one or more other users of devices that interact with the user (Also contemplated that the transformation may occur based on a determined device interaction information (e.g., the advertisement adapts according to the determination that the device/user is within proximity of other users/friends . . . hence, a group based advertisement is caused to be rendered).

9. A method of claim 7, wherein the (1) data and/or (2) information and/or (3) at least one signal are further based, at least in part, on the following:
a report of the at least one transformation; and
a transmission of the report to one or more advertisers, one or more advertising platforms, one or more application developers, one or more network operations, one or more service providers, one or more users associated with the device, or a combination thereof.

10. A method of claim 1, wherein the determining of the advertisement information comprises at least one of: (a) determining whether to present a new advertisement, (b) determining whether to maintain a currently presented advertisement, (c) determining whether to present one or more advertisements from a different advertisement channel, (d) determining whether to pre-fetch one or more additional advertisements, (e) determining whether to present one or more context-relevant advertisements in at least substantially real time, or (f) a combination thereof.

11. An apparatus comprising:
at least one processor; and
at least one memory including computer program code for one or more programs,
the at least one memory and the computer program code configured to, with the at least one processor, cause the apparatus to perform at least the following,
determine one or more user interface state changes associated with one or more applications executing at a device;
determine one or more policies for presenting advertisement information at the one or more applications, the device, or a combination thereof; and
process and/or facilitate a processing of the one or more policies to determine advertisement information for presentation at the one or more applications, the device, or a combination thereof based, at least in part, on the one or more user interface state changes.

12. An apparatus of claim 11, wherein the apparatus is caused to:
determine interaction information with respect to the one or more applications, the device, or a combination thereof; and
process and/or facilitate a processing of the interaction information to determine the one or more user interface state changes.

13. An apparatus of claim 12, wherein the interaction information includes, at least in part, user interface context information, user interface action information, device context information, system context information, other device interaction information or a combination thereof.

14. An apparatus of claim 11, wherein the one or more policies specify one or more criteria for determining (a) a duration for presenting the advertisement information, (b) an expiration date and/or time for presenting the advertisement information, (c) a sequence for presenting the advertisement information, (d) the one or more user interface state changes for triggering the presentation of advertisement information, (e) presentation of the advertisement based, at least in part, on network status information, or (f) a combination thereof.

15. An apparatus of claim 14, wherein the one or more policies, the one or more criteria, or a combination thereof are specified, at least in part, by one or more advertisers, one or more advertising platforms, one or more application developers, one or more network operations, one or more service providers, one or more users associated with the device, or a combination thereof.

16. An apparatus of claim 11, wherein the apparatus is caused to:
cause, at least in part, dynamic configuration of the one or more policies at an advertising client associated with the one or more applications, the device, or a combination thereof.

17. An apparatus of claim 11, wherein the apparatus is caused to:
determine that the one or more policies relate, at least in part, to one or more rules for at least one transformation of the advertisement information; and
process and/or facilitate a processing of the advertisement information to cause, at least in part, the at least one transformation for presentation at the one or more applications, the device, or a combination thereof.

18. An apparatus of claim 17, wherein the at least one transformation includes transforming the advertisement information based, at least in part, on (a) a specified age range of a user of the device, (b) one or more user preferences, (c) one or more device capabilities, (d) or a combination thereof . . . or one or more other users of devices that interact with the user (Also contemplated that the transformation may occur based on a determined device interaction information (e.g., the advertisement adapts according to the determination that the device/user is within proximity of other users/friends . . . hence, a group based advertisement is caused to be rendered).

19. An apparatus of claim 17, wherein the apparatus is caused to:
cause, at least in part, generating of a report of the at least one transformation; and
cause, at least in part, transmission of the report to one or more advertisers, one or more advertising platforms, one or more application developers, one or more network operations, one or more service providers, one or more users associated with the device, or a combination thereof.

20. An apparatus of claim 11, wherein the determining of the advertisement information comprises at least one of: (a) determining whether to present a new advertisement, (b) determining whether to maintain a currently presented advertisement, (c) determining whether to present one or more advertisements from a different advertisement channel, (d) determining whether to pre-fetch one or more additional advertisements, (e) determining whether to present one or more context-relevant advertisements in at least substantially real time, or (f) a combination thereof.
